(19) United States
(12) Patent Application Publication
(10) Pub. No.: US 2008/0163618 A1
(43) Pub. Date: Jul. 10, 2008

(54) MANAGED STORAGE AND USE OF GENERATED ENERGY

(76) Inventor: Marius Angelo Paul, Fullerton, CA (US)

Correspondence Address: BLACK LOWE & GRAHAM, PLLC, 701 FIFTH AVENUE, SUITE 4800, SEATTLE, WA, 98104, US

(21) Appl. No.: 11/772,458

(22) Filed: Jul. 2, 2007

Related U.S. Application Data
(60) Provisional application No. 60/817,882, filed on Jun. 30, 2006.

(51) Int. Cl. F16D 31/02; F02B 63/04

(52) U.S. Cl. 60/407; 290/1 A

(57) ABSTRACT

An apparatus for driving a turbine connected to a generator for generating power to supply to a grid the power derived from a rotating shaft includes a transmission for selectably driving either of a compressor or a direct current motor generator. The compressor compresses ambient air changing phase to liquid air. The direct current motor generator generates a current at a constant voltage for water electrolysis. A first bell containing a cathode collects elemental hydrogen; a second bell containing an anode collects elemental oxygen. The elemental hydrogen burns in the presence of the elemental oxygen to produce a highly energetic exhaust. A valve selectably admits either of the highly compressed air or the highly energetic exhaust into the turbine to drive the turbine thereby energizing the generator to supply the grid.

### PRIORITY CLAIM

This application claims priority from the provisional application dated Jun. 30, 2006 entitled Eternal Power Systems and having the Ser. No. 60/817,882, the provisional application being wholly incorporated by this reference.

### FIELD OF THE INVENTION

This invention relates generally to energy storage and, more specifically, to managed selection of storage means.

### BACKGROUND OF THE INVENTION

After electricity is generated, its voltage is increased by transformers and it is then delivered to the end use customer using the electricity grid that consists of bulk transmission and local distribution lines. The demand for electricity is highly variable and changes throughout the day, as well as throughout the year. Electrical systems require equilibrium between electricity production and demand. Currently there is no technology that could provide electricity storage to balance the demand/load cycle, i.e. the electricity has to be produced on demand and is consumed immediately. If production is greater or smaller than demand, frequency and voltage will change, which can create technical problems or even blackouts.

Generally, a mix of resources is needed to match electricity generation with demand. Electricity system operators “dispatch” generating units based primarily on operating cost or market bid price considerations, generally looking first to the most economic units for the expected load profile. The plants that are cheapest to operate will therefore run at full capacities most of the time (coal, nuclear, and hydro) whereas the output of more expensive power sources is adapted to respond to peak demand (oil, gas and peaking hydro). The specific power generation mix of any generation company or group of generation companies will vary according to the generating resources available to them, the different characteristics and economics of the fuel choices available, as well as restrictions, such as prohibitions to dispatch certain power sources on smog days.

Renewable power generators other than reservoir hydro are generally self-scheduling and are contracted to run at their maximum possible output, i.e. the power they can deliver at any time of day will be fully fed into the electricity grid. This changes the way in which other generation sources must be dispatched. It may reduce or significantly change the need for peaking power plants to be run, and it may in some systems change how some base load capacity is employed. According to conventional methodology, highly intermittent renewables, such as wind, are only useful if other generation facilities on the grid are correspondingly used to match the load to the generation capacity. Additionally, these facilities must quickly respond to adapt to changing generation from renewable energy plants, for example when the wind does not blow.

Renewable power generators have additional problems when incorporated into a power grid. Most renewable power is not only self-scheduling but frequency-wild. For example, a windmill is generally more complex than necessary to simply generate power because of the requirement that the power be of the same frequency of alternating current as the grid. Achieving the synchronization can only be done by conditioning the movement of the windmill, i.e. feathering the blades to achieve a uniform rotational speed, or conditioning the power, i.e. rectifying to direct current and then chopping to meet the frequency of the grid. Either is an inherently inefficient method of exploiting the rotational movement of the windmill. Energy is wasted during either process and matching the variability of the wind to the imposed frequency of the grid

What is needed is an apparatus to store the output from renewable power generators thereby making the renewable power generators suitable for supplying power at times of peak load. Allowing renewable power generators to supply power to satisfy peak load, removes the self-scheduling quality of the power generators allowing them to augment, rather than to displace other generation facilities on the grid.

### BRIEF DESCRIPTION OF THE DRAWINGS

The preferred and alternative embodiments of the present invention are described in detail below with reference to the following drawings.

FIG. 1 is a block diagram showing the liquefaction of air exploited as a means of turning a motor generator; and,

FIG. 2 is a block diagram showing the electrolysis of water as a means for turning a motor generator.

### DETAILED DESCRIPTION OF THE PREFERRED EMBODIMENT

A system and method for exploiting renewable power generators to power a grid at peak load periods includes drawing rotary motion from the power generator to turn a motor generator connected to the grid. Two alternate means of producing storable energy means are alternately or complementarily used to storably retain energy for use at times of peak load. The first means is generally to compress ambient air to liquefaction for storage. Solar energy is used to suitably expand the liquid air to drive a turbine to, in turn, rotate the motor generator to power the grid. The second means includes the electrolysis of water into storable hydrogen and oxygen gases. When peak load occurs, the hydrogen is combusted to drive the turbine which again, in turn, rotates the motor generator to power the grid.

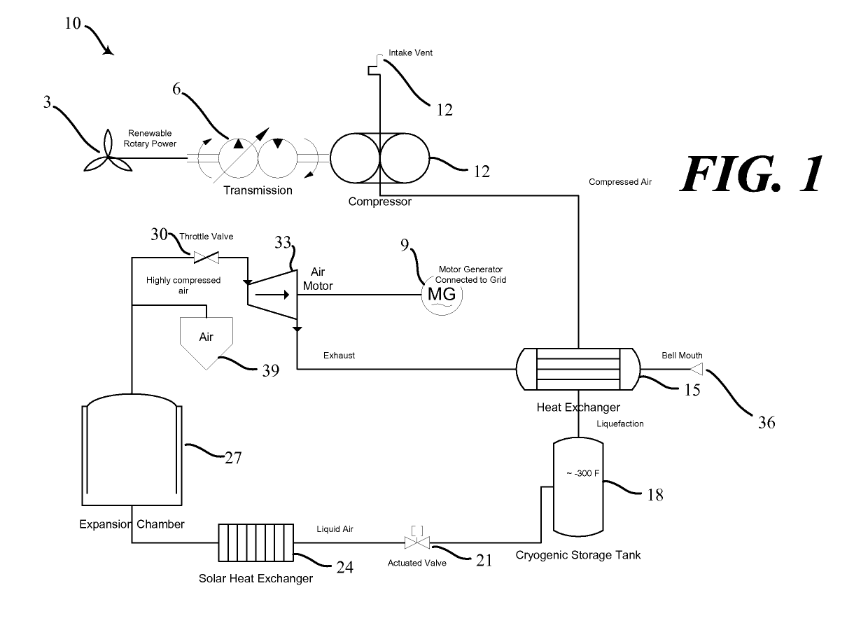

Referring to FIG. 1, a renewable power generator such as a windmill, a tidal turbine, a hydraulic turbine, or a geothermal turbine, by way of non-limiting example shall all be referred to herein as a windmill 3 without the intent to limit the power source to only wind powered devices. Ultimately, the only requirement is that the renewable power source be configured to provide rotating motivation to a shaft. Thus, the windmill 3 refers to any energy source along with the rotated shaft.

The windmill 3 drives a transmission 6. In one non-limiting embodiment, the transmission 6 includes a generator producing a current at a voltage, the current being used to energize an electric motor. Non-limiting examples of such electric transmissions 6 are employed in such hybrid vehicles such as the Toyota™ Prius™ or the Honda™ Insight™. The advantage of such an electrical transmission 6 is the power generated at the generator is available for conditioning to optimally and efficiently apply the power to the motor to turn the output shaft.

In a second non-limiting embodiment, the transmission 6 is a mechanical transmission 6 such as, by way of example, an planetary transmission 6 used only to present the rotation movement of the output shaft of the transmission 6 to a compressor 12

The transmission 6, in any embodiment, drives the compressor 12 to draw ambient air through an intake vent 12 to highly compress ambient air to high pressure air for accumulation as a liquid in a cryogenic insulated storage tank 18. The air is, in one embodiment, compressed to about 200 atmospheres thereby effecting the phase change to liquefied air or liquid air. To assist the phase change from compressed air to liquid air, the highly compressed air gives up heat to a heat exchanger 15. Because liquid air is about 794 times as dense as atmospheric air, a great amount can be stored in a relatively small storage tank 18 which is suitably insulated. Because, liquid air is air that has been liquefied by compression and cooled to very low temperatures, the storage tank 18 is configured as a Dewar flask, in one non-limiting embodiment.

The relationship between temperature, pressure and volume of a gas is simply described by the various gas laws. When volume is increased in an irreversible process, the gas laws do not uniquely determine what happens to the pressure and temperature of the gas. Isentropic expansion, in which the gas does positive work in the process of expansion, always causes a decrease in temperature. In 1895, Carl von Linde perfected a new process for producing large quantities of oxygen, which Air Products and all other industrial gas manufacturers still use over a century later.

Carl von Linde's apparatus for the liquefaction of air combined the cooling effect achieved by allowing a compressed gas to expand (the Joule-Thomson effect first observed by James Prescott Joule and Lord Kelvin) with a counter-current heat exchange technique that used the cold air produced by expansion to chill ambient air entering the apparatus. In physics, the Joule-Thomson effect, or Joule-Kelvin effect, is a process in which the temperature of a real gas is either decreased or increased by letting the gas expand freely at constant enthalpy (which means that no heat is transferred to or from the gas, and no external work is extracted). Over a period of time this effect gradually cooled the apparatus and air within it to the point of liquefaction.

Given the insulation of the storage tank 18, liquid air can be stored therein until the times of peak load occur. The tank 18 is sized to allow the accumulation of liquid air over cycles of low load. The capacity of the tank directly relates to the ability to store energy and the sizing of the tank is designated to optimize the storage function of the tank as it relates to load.

As the need to use the stored energy is perceived, switching logic (not shown) actuates an actuated valve 21 to open and allow the liquid air stored in the storage tank 18 to flow into a solar powered heat exchange 24. At ambient temperatures such as those encountered in the continental United States, liquid air can absorb heat rapidly and revert to its gaseous state. In making the phase change to a gaseous state, the air expands approximately 794 times in volume. To facilitate this expansion in volume, in one non-limiting embodiment, an expansion chamber is provided. Alternatively, the expansion occurs within connective plumbing allowing the phase change to occur.

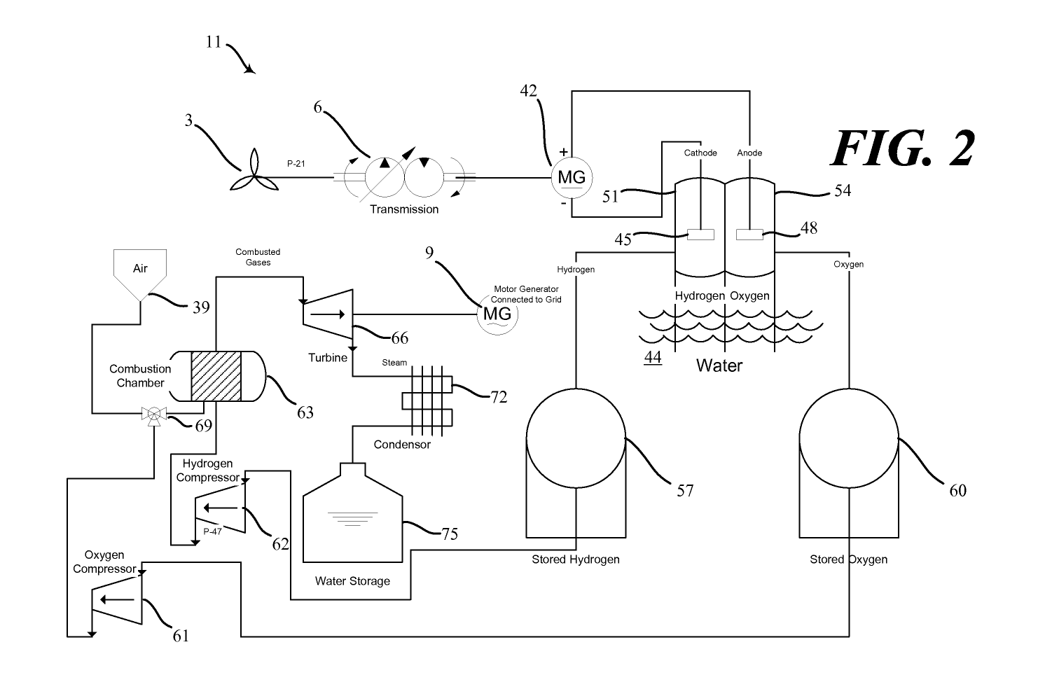

A throttle valve 30 is used to allow the highly compressed air to drive an air motor 33 at an optimal speed to turn the motor generator 9 connected to the power grid such that the generator synchronizes to the power grid and the resulting power is used to supply the grid. A conduit 39 conducts the compressed air to facilitate combustion of hydrogen as set forth with reference to FIG. 2.

Common designs of air motors 33 include rotary vane, axial piston, radial piston, gerotor, turbine, V-type, and diaphragm. Rotary vane, axial- and radial-piston, and gerotor air motors 33 are most commonly used for industrial applications. These designs operate with highest efficiency and longevity from lubricated air. Of course, specific designs are available for applications where lubricated air proves undesirable. Turbine motors are used where very high speed but low starting torque are useful. V-type and diaphragm air motors 33 are used primarily for special applications and generally are not useful for turning a motor generator 9.

Piston air motors 33 are used in applications requiring high power, high starting torque, and accurate speed control at low speeds. They have either two, three, four, five, or six cylinders arranged either axially or radially within a housing. Output torque is developed by pressure acting on pistons that reciprocate within the cylinders.

Motors with four or more cylinders provide relatively smooth torque at a given operating speed because power pulses overlap: two or more pistons undergo a power stroke at any time within a revolution. Motors designed with overlapping power strokes and accurate balancing are vibration-free at all speeds.

Power developed by a piston motor depends on the inlet pressure, the number of pistons, and piston area, stroke, and speed. To that end, the throttle valve 30 is used to regulate the inlet pressure and volume. At any given inlet pressure, more power can be obtained from a motor that runs at a higher speed, has a larger piston diameter, more pistons, or longer stroke. Speed-limiting factors are the inertia of the moving parts (which has a greater effect in radial- than in axial-piston motors) and the design of the valve that controls inlet and exhaust to the pistons.

Radial- and axial-piston motors have one significant limitation: they are internally lubricated, so oil and grease supplies must be checked periodically and replenished. They must be mounted in a horizontal position to provide proper lubrication to bearing areas. However, at least one manufacturer offers a radial-piston motor with the shaft vertically-down as a standard configuration. Other mounting positions from any manufacturer require special lubrication configurations.

Radial-piston motors feature robust, oil-lubricated construction and are well-suited to continuous operation. They have the highest starting torque of any air motor 33 and are particularly beneficial for applications involving high starting loads. Overlapping power impulses provide smooth torque in both forward and reverse directions. Sizes range to about 35 hp for speeds to 4,500 rpm.

Axial-piston motors are more compact than radial-piston motors, making them ideal for mounting in close quarters. Their design is more complex and costly than vane motors, and they are grease lubricated. However, axial-piston motors run smoother and deliver maximum power at much lower speeds than vane motors can. Smaller and lighter than electrical gear motors of the same power rating; axial-piston motors also tolerate higher ambient temperatures. Maximum size is about 3½ hp.

Rotary vane motors normally are used in applications requiring low- to medium-power outputs. Simple and compact vane motors most often drive portable power tools, but certainly are used in a host of mixing, driving, turning, and pulling applications as well.

Vane motors have axial vanes fitted into radial slots running the length of a rotor, which is mounted eccentric with the bore of the motor's body housing. The vanes are biased to seal against the housing interior wall by springs, cam action, or air pressure, depending on design. The centrifugal force that develops when the rotor turns aids this sealing action. Torque develops from pressure acting on one side of the vanes. Torque at the output shaft is proportional to the exposed vane area, the pressure, and the moment arm (radius from the rotor centerline to the center of the exposed vane) through which the pressure acts.

In a multi-vane motor, torque can be increased at a given speed by increasing the air pressure at the motor inlet to increase the pressure imbalance across the motor vanes. However, there are tradeoffs: increasing inlet air pressure increases air supply costs and generally leads to faster wear and shorter vane life.

Output power at a given speed determines air consumption. A small motor producing 1 hp and operating at 2,000 rpm using 80-psi air consumes the same volume of compressed air as a larger air motor 33 producing 1 hp at 2,000 rpm using air at a lower, more economical pressure.

Rotary vane air motors 33 are available with three to ten vanes. Increasing the number of vanes reduces internal leakage or blow-by and makes torque output more uniform and reliable at lower speeds. However, more vanes increase friction, cost of the motor, and decrease efficiency.

If, in a 3-vane design, one vane sticks in a retracted position, it can prevent the air motor 33 from starting under load. Spring-biasing the vanes against the housing wall, porting pressure air to the base of the vanes, or camming the base of the vane prevents this problem, as does using a motor with four or more vanes.

Vane motors operate at speeds from 100 to 25,000 rpm at the rotor—depending on housing diameter—and deliver more power per pound than piston air motors 33. Because the vanes slide against the housing wall, many vane motors require lubricated air, particularly if short duty cycles are followed by long inactive periods. However, more and more motors continue to be designed to operate on non-lubricated air to serve critical applications and environmental concerns.

Operation of ungoverned vane air motors 33 with no load at high speed should be avoided. When a multi-vane motor operates ungoverned under no load, its high speed can heat and char the vane tips as they rub against the cylinder wall. Abnormal wear and damage to other motor parts should also be expected.

Gerotor air motors 33 deliver high torque at low speed without additional gearing. When coupled with a 2-stage orbital planetary gear train, gerotor power elements provide torque at speeds down to 20 rpm. These motors are well suited to hazardous-environment applications where relatively high torque is needed in limited space.

Low-speed/high-torque gerotor air motors 33 can deliver torque exceeding 250 lb-in. within a speed range of 20 to nearly 100 rpm from a 90-psi supply of compressed air. They are rated for continuous operation at supply pressures to 150 psi. Low rotating inertia of the gerotor design produces instant starting, stopping, or change in direction when the valve supplying the motor is shifted. Furthermore, the design prevents the motor from coasting or being backdriven, which can eliminate the need for external brakes. Like vane motors, they are much less sensitive to mounting orientation than piston motors are.

Efficiency of an air motor 33 is defined as the ratio of the actual power output to the theoretical power available from the compressed air for the expansion ratio at which the machine is operating. Turbines convert pneumatic power to mechanical power at about 65% to 75% efficiency. Turbine efficiency is higher than other air motors 33 because sliding contact of parts does not occur to cause internal friction. As a result, there is no need for extensive lubrication. The absence of lubricating oil dramatically improves cold-weather performance.

Until recently, turbine air motors 33 typically were used for applications requiring very high speed and very low starting torque—dental drills and jet aircraft engine starters being most typical. Now, however, turbine technology is being applied to starting small, medium, and large reciprocating engines. Turbine technology offers simple, highly efficient pneumatic starters that require no lubrication of their supply air, tolerate contaminants in the supply air, and need little maintenance. Turbine motors are relatively compact and light for their power-delivery capability. Higher gear ratios—from 9:1 through 20:1—provide high stall torque and versatility for a variety of engines. Turbine horsepower is easily changed by limiting air flow through the motor.

Operation of a turbine air motor 33 involves the throttle valve 30 that directs and meters air to a turbine wheel or rotor. It changes high-pressure, low-velocity air flow to low-pressure, high-velocity. The mass-flow rate of air passing through a turbine determines its horsepower. Changing the number of nozzles or nozzle passages changes power output proportionally. If a 16-nozzle starter is reduced to 8 nozzles, the altered starter will produce half the power of the original. Therefore, within the same basic starter configuration, many models can be designed that have a wide range of inlet pressures, cranking speeds, and cranking or stall torques. This capability, combined with various gearboxes, allows production of low-cost starters for a wide variety of applications. For example: turbine starters are available to crank engines with displacements from 305 to 23,800 in.3 at pressures from 40 through 435 psig.

Power characteristics of air motors 33 are similar to those of series-wound DC motors. With a constant inlet pressure at the throttle valve 30, the brake horsepower of an air motor 33 is zero at zero speed. Power increases with increasing speed until it peaks at around 50% of free speed (maximum speed under no-load conditions). At the peak point, torque decrease balances speed increase. Power decreases to zero when torque is zero, because all the inlet air power is used to force the volume of air required to maintain this speed through the motor.

Torque output for an air motor 33 of given displacement theoretically is a function of the differential pressure and a constant that depends on the physical parameters of the motor. Therefore, regardless of speed, torque should be constant for a given operating pressure. Actually, this is not the case, because as air flow increases through the motor, pressure losses in the inlet and outlet lines consume a greater portion of the supply. In practice, torque reaches its greatest value shortly beyond zero speed, and falls off rapidly until it reaches zero at free speed.

Starting torque is the maximum torque the motor can produce under load. It is about 75% of stall torque. It takes more torque to start an air motor 33 than to keep it running. Do not confuse stall and starting torques. If the air motor 33 load exceeds its starting torque, the motor will not start. Stall torque, the maximum torque of an air motor 33, is about twice the torque at rated horsepower, and can be determined from information on power and speed given in manufacturers' literature.

Controlling air pressure supplied to the motor is the simplest and most efficient method of changing the motor's operating characteristics. Conversely, not maintaining the required supply pressure at the motor inlet certainly degrades operating characteristics.

Because air motors 33 are constant-displacement devices, their speed, theoretically, is directly proportional to air flow rate. This is true if there is no leakage, but leakage certainly affects motor speed. Leakage increases with pressure, and is nearly constant at any given pressure. Thus, at fixed speed, air consumption increases as supply pressure increases; at low speeds, a much higher proportion of total flow is lost through leakage. Interestingly, total flow per revolution decreases as speed increases. Leakage also decreases slightly as speed increases, because less time is available for leakage.

The exhaust from the air motor 33 is much colder than the highly compressed air that enters the air motor 33. During gas molecule collisions, kinetic energy is temporarily converted into potential energy. As the average intermolecular distance increases, there is a drop in the number of collisions per time unit, which causes a decrease in average potential energy. Again, total energy is conserved, so this leads to an increase in kinetic energy (temperature). Below the Joule-Thompson inversion temperature, the former effect (work done internally against intermolecular attractive forces) dominates, and free expansion causes a decrease in temperature. Because of this, further efficiency is gained when the exhaust is used to further cool the heat exchanger 15 to facilitate the phase change and liquefaction of the highly compressed air for storage in the cryogenic tank 18.

The second means of exploiting the energy provided by the rotating shaft of the windmill 3 is explored with reference to FIG. 2. After passing through the optional transmission 6 (explained above), the output of the output shaft turns a direct current (DC) motor generator 42 to produce a potential difference between a cathode 45 and an anode 48. Electrolysis of water 44 is an electrolytic process which decomposes water into oxygen and hydrogen gas due to the flow of electric current from the DC motor generator 42. The voltage creates a current in the water 44 that is equal to the voltage of generator 42 divided by the resistance of the water, as per Ohm's law. For water 44 to conduct substantial electric current, an electrolyte is required. In sea water 44, the electrolyte may be the salt present in the water 44. Decomposition occurs according to the equation:

2H₂O_{(I)}→2H_{2(g)}+O_{2(g)}

The energy efficiency of water electrolysis varies widely. The efficiency is a measure of what fraction of electrical energy used is actually contained within the hydrogen. Some of the electrical energy is converted to heat, a useless by-product. Some reports quote efficiencies between 50-70% This efficiency is based on the Lower Heating Value of Hydrogen. The Lower Heating Value of Hydrogen is thermal energy released when hydrogen is combusted. This does not represent the total amount of energy within the hydrogen, hence the efficiency is lower than a more strict definition. Other reports quote the theoretical maximum efficiency of electrolysis. The theoretical maximum efficiency is between 80-94%. The theoretical maximum considers the total amount of energy absorbed by both the hydrogen and oxygen. These values only refer to the efficiency of converting electrical energy into hydrogen's chemical energy. The energy lost in generating the electricity is not included. For instance, when considering a power plant that converts the heat of nuclear reactions into hydrogen via electrolysis, the total efficiency is more like 25-40%.

The produced elemental hydrogen gas is collected at the cathode 45 in a first bell 51 and the produced elemental oxygen gas is collected at the anode 48 in a second bell 54 and each are conducted to their respective storage tanks, the hydrogen tank 57 and the oxygen tank 60. The storage tanks may be any suitable storage tank for each of the elemental gases. For example, such storage tanks might be configured as compressed hydrogen gas tanks, liquid hydrogen tanks, metal hydrides, carbon-based materials such as high surface area sorbents, and chemical hydrogen storage. Storage as a gas or liquid or storage in metal hydrides or high surface area sorbents constitute “reversible” hydrogen storage systems.

From the oxygen storage tank 60, the oxygen is drawn by an oxygen compressor 61 that raises the pressure within the combustion chamber enhancing the molar concentration within the combustion chamber. From the hydrogen storage tank 57, the hydrogen is conducted to a combustion chamber 63 for burning. A hydrogen compressor 62 suitably pressurizes the fed hydrogen to enhance combustion thereby raising the efficiency of the combustion within the combustion chamber 63. The only byproduct of burning hydrogen in oxygen is water that is free from CO2, NOx and SOx emissions.

Combustion of hydrogen within the combustion chamber 63 requires at least a stoichiometric supply of oxygen for complete combustion, i.e. to recombine the two hydrogen atoms with one oxygen atom to create steam in combustion. Combustion turbines are mass flow engines with their power output dependent on the properties of air flowing through the engine. As the inlet air temperature increases, the air's density, and therefore the mass flow through the turbine decreases.

Cooling combustion turbine inlet air, however, increases the air's density and mass flow through the turbine, thereby increasing the pressure ratio and reducing the work of compression.

Reducing the work of compression is important, for when hot gases from the combustor expand in the turbine, roughly ⅔ of the mechanical work is used to drive the air compressors, while only one-third of the mechanical work is available for useful power output. Thus, cooling inlet air during periods of high ambient temperatures is a cost-effective means of increasing the power output of the generator, while also reducing the heat rate of the combustion turbine. In two alternative embodiments, the oxygen is supplied; in the first from the oxygen storage tank 60 and in the other from gaseous air produced in accord with FIG. 1 and conducted through a conduit 39. A switchable valve 69 may, optionally, be employed to switchably admit both of the oxygen and expanded air into the combustion chamber 63 using the expanded air as a coolant in accord with the determined conditions in order to suitably combust the hydrogen.

In one embodiment, combustion occurs in the combustion chamber 63 the combusted gases drive a turbine 66 to produce a rotation of a shaft in an advanced Rankine cycle, a high-temperature, double-reheat Rankine cycle. In the non-limiting embodiment, the exploiting of the Rankine cycle includes combustion in two hydrogen-oxygen combustor chambers 63 for heating and reheating. The combustion chambers 63 generate high-temperature steam by combusting hydrogen and oxygen, whereas the conventional Rankine cycle uses a superheater and a reheater as part of a boiler in which steam temperature must be kept under 600° C. because of the boiler material's temperature limit. Use of a combustion chambers instead of a boiler enables significantly higher steam temperatures, which boosts thermal efficiency. In such an embodiment, a hydrogen turbine's efficiency could reach 71% (LHV, gross) if its firing temperature can be raised to 1,973K (1,700° C.). In addition to its higher efficiency, a hydrogen-fuel turbine would also provide superior environmental performance as its only byproduct is clean water.

It is noted that the turbine 66 and the turbine 33 may either be the same turbine or distinct turbines. In fact, in an embodiment, both of the compressed air and the burning of the hydrogen may simultaneously occur allowing the expanded air to cool the internal mechanism of the turbine during combustion.

Driving the turbine 66 causes the generation of electricity at the motor generator 9 just as driving the turbine 33 causes generation of electricity and supplying it to the grid.

As has been earlier indicated, the principal byproduct of combustion of hydrogen is steam. In many environments where the combustion of hydrogen is an appropriate means to schedule capacity at peak loads, the acquisition of water may also be advantageous. In an embodiment, the turbine 66 exhausts steam into a condenser 72 causing the steam to change phase to become water. The water is collected in a water storage reservoir 75 for use.

While the preferred embodiment of the invention has been illustrated and described, as noted above, many changes can be made without departing from the spirit and scope of the invention. For example, either of the liquid air or the hydrogen and oxygen gasses may be transported to a remote site thereby splitting the apparatus between two locales. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. An apparatus for driving a turbine connected to a generator for generating power to supply to a grid the power derived from a rotating shaft, the apparatus comprising:
a transmission for selectably driving either of a first compressor or a direct current motor generator;
the first compressor configured to compress ambient air to cause the air to change phase to liquid air,
a solar heat exchanger to expand the liquid air into highly compressed air;
the direct current motor generator to generate a current at a constant voltage between a positive terminal and a negative terminal;
a water electrolysis vessel including:
a first bell containing a cathode in operative connection to the negative terminal, configured to collect elemental hydrogen; and
a second bell containing an anode in operative connection to the positive terminal, configured to collect elemental oxygen;
a combustion chamber to combust the elemental hydrogen in the presence of the elemental oxygen to produce a highly energetic exhaust; and
a valve for selectably admitting either of the highly compressed air or the highly energetic exhaust into the turbine to drive the turbine thereby energizing the generator to supply the grid.

2. The apparatus of claim 1, wherein the first compressor includes a heat exchanger to remove heat from the ambient air further facilitating the phase change.

3. The apparatus of claim 2, wherein the heat exchanger is cooled by highly compressed air exiting the turbine.

4. The apparatus of claim 1, wherein the first bell is in conductive communication with a hydrogen storage tank and the second bell is in conductive communication with an oxygen storage tank.

5. The apparatus of claim 1, wherein the oxygen storage tank is in further conductive communication with a second compressor for compressing the elemental oxygen for admission into the combustion chamber.

6. The apparatus of claim 1, further comprising a liquid air storage tank.

7. The apparatus of claim 6, wherein the liquid air storage tank includes an actuated valve.

8. The apparatus of claim 1, wherein the solar heat exchanger includes an expansion tank.

9. The apparatus of claim 1, wherein a throttle valve is interposed between the turbine and the solar heat exchanger to control the admission of air into the turbine.
